(19) United States
(12) Patent Application Publication
(10) Pub. No.: US 2013/0328387 A1
(43) Pub. Date: Dec. 12, 2013

(54) SUPERCAPACITOR VEHICLE AND ROADWAY SYSTEM

(71) Applicants: Sagar Venkateswaran, Glen Mills, PA (US); Yoshihiko Ariizumi, Philadelphia, PA (US); Franciscus Praliktohadi, Philadelphia, PA (US)

(72) Inventors: Sagar Venkateswaran, Glen Mills, PA (US); Yoshihiko Ariizumi, Philadelphia, PA (US); Franciscus Praliktohadi, Philadelphia, PA (US)

(21) Appl. No.: 13/491,665

(22) Filed: Jun. 8, 2012

(51) Int. Cl. B60L 1/00

(52) U.S. Cl. 307/9.1

(57) ABSTRACT

An electric supercapacitor module is utilized as the primary power source for the propulsion unit of electrically powered vehicles. The vehicle operates in conjunction with roadway embedded wireless chargers which continually charge the vehicle's supercapacitor while the vehicle is in motion to maintain the motion and materially increase the vehicle's range without limitation.

### BACKGROUND OF THE INVENTION

The convergence of three factors, namely peak oil, supply constraints, and regulations to control greenhouse gases, have created the incentive for markets to move away from hydrocarbons for transport applications. In early versions, automobile manufacturers have essentially attempted to replicate the experience of a gas powered engine utilizing an electric battery storage unit to replace the gas tank, the battery unit being the main driver for vehicle propulsion. This resulted in hybrid and electric vehicles being introduced into the market, a small step in reducing hydrocarbon emissions. However, electric vehicles have serious limitations with respect to range, practicality, price, and safety.

The range of an electric vehicle is typically only about 100 miles, while the range of a gasoline powered vehicle is 400 miles or more. A gasoline powered vehicle can be refueled in about ten minutes, but an electric vehicle can take up to four hours, even assuming the best of conditions, e.g. fast charging infrastructure, strong batteries, etc.

Safety and cost issues related to electric vehicles can be best appreciated by considering the Chevy Volt. To prevent thermal runaways in lithium ion batteries, newer lithium ion materials which were safer were introduced in vehicles like the Volt. However, these materials compromised on energy density and thus have resulted in lower vehicle range. Significantly, this has also resulted in safety problems, as Volt batteries have caught fire after their vehicles have experienced otherwise minor accidents.

Safety and range issues aside, the cost of even the most inexpensive electric vehicle is almost twice the cost of a comparable gas powered automobile. This places electric vehicles out of reach of mainstream consumers.

### SUMMARY OF THE INVENTION

The present invention uniquely utilizes electric supercapacitors, also known as ultracapacitors or double-layer capacitors, as the primary power source for the propulsion unit of electrically powered vehicles. The vehicle operates in conjunction with roadway embedded wireless chargers which continually charge the vehicle's supercapacitor while the vehicle is in motion to maintain the motion, thus materially increasing the vehicle's range without limitation.

Batteries and supercapacitors are two distinct energy storage devices, each having a unique set of characteristics. Batteries have high energy density and low leakage current and can supply consistent power at a stable voltage. On the other hand, supercapacitors have long cycle life, high power density, and high current capability. Supercapacitors also perform better than batteries at both low and high temperatures.

Thus, by employing a supercapacitor as the primary source of electrical power, the result will be a lighter, less expensive vehicle with enhanced power performance. Such a vehicle also comprises a power source with better extreme temperature behavior and a low range if used alone.

The supercapacitor has one important drawback. It can only sustain a very low driving range of perhaps one to two miles. However, the ability of a supercapacitor to charge and discharge at high rates provides a remedy to this problem. In fact, utilization of a supercapacitor results in significant advantages when it is wirelessly charged with a Dynamic Wireless Charging System (DWCS) while the vehicle in which it is located is in motion. Although the supercapacitor is far smaller than a battery in energy density and thus it can only provide a minuscule driving range by itself, in combination with a DWCS, it can relatively inexpensively provide an unlimited driving range. A battery based DWCS can have a construction cost at least ten times greater than a supercapacitor-based system.

Implementation of the system of the present invention, involves the “electrification” of roadways using wireless chargers to charge the supercapacitor vehicle. This eliminates the necessity of the driver to physically charge the vehicle. The system allows the vehicle to be charged without direct connection to a power source. No plug-in is required. Parking or driving over the wireless charger is sufficient to maintain the electrical energy in the vehicle.

Since the supercapacitor vehicle is designed to be charged continuously, both large storage capability and high energy density become irrelevant. As a result, supercapacitor vehicles can be lighter in weight, in stark contrast to the traditional electric vehicle which is much heavier, due to the size of its battery, more costly, and faced with significant safety and environmental issues.

The supercapacitor vehicle and system of the present invention results in environmental benefits as well. Supercapacitors have a vastly longer life than batteries and also use renewable carbon in their manufacture. On the other hand, batteries utilize rare earth and other geopolitically sensitive material like lithium, which, when batteries are discarded, detrimentally effect the environment.

The supercapacitor vehicle/wireless charger system of the present invention is conducive to being incorporated into public transportation systems, e.g. trolley systems, in urban locals. This would also have a positive environmental impact, as well as improving traffic flow and ambient aesthetics by eliminating unsightly electrical wires and tracks.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a representation of the configuration of significant components of the supercapacitor vehicle of the present invention.

FIG. 2 is a representation of the significant components of the wireless charger system of the present invention.

FIG. 3 is a top view showing sections of a representation of the electrified road system to be used in the present invention.

FIG. 4 is a circuit schematic showing the basic circuitry of the components of the present invention.

FIG. 5 is a discharge comparison graph.

FIG. 6 is a view of an exemplary supercapacitor module to be utilized in the present invention.

### DETAILED DESCRIPTION OF THE INVENTION

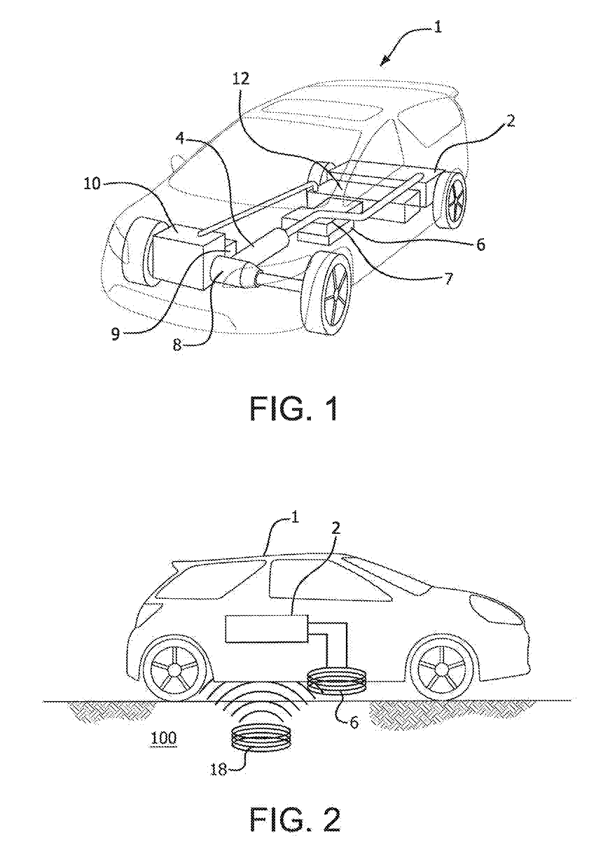

The basic drive component of exemplar supercapacitor vehicle 1, shown in FIG. 1, comprises supercapacitor module 2, which is the primary source of electricity to power electric motor 4. Wireless charger electrical energy receiver coil 6 can be located underneath the mid-section of the chassis of vehicle 1, below power electronics 7. Vehicle 1 is not designed to be a hybrid, but auxiliary power to drive transmission 8 is available from battery 9 and gas engine 10, fueled from gas tank 12.

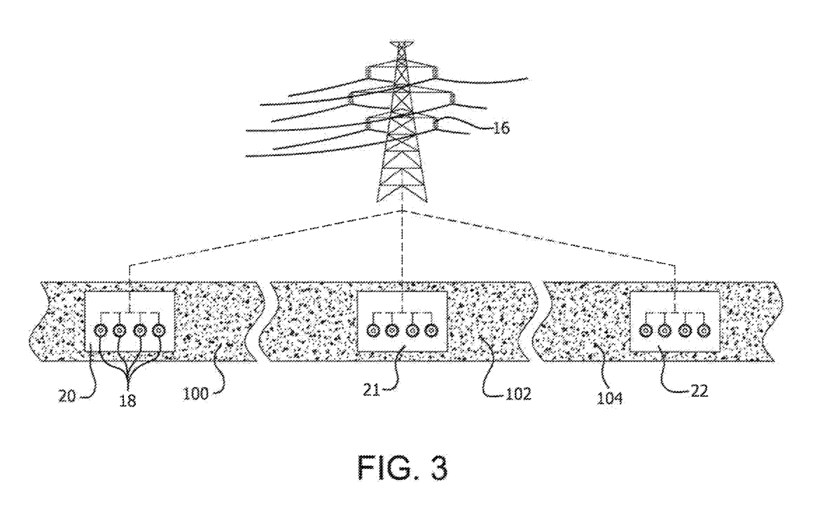

As seen in FIGS. 2 and 3, the DWCS, embedded in roadway 100, comprises electric energy transmitter coils 18 housed within charging pads 20, 21, and 22. Electrical energy is supplied to coils 18 from a remote electric power grid and energy transmission system 16, known in the art. Transmitter coils 18 and receiver coil 6 in vehicle 1 are tuned to the same electromagnetic frequency, such that electrical energy is readily transferable between the transmitter coils and the receiver coil.

As a vehicle travels over roadway 100, as seen in FIG. 3, it passes over charger pad 20. Transmitter coils 18 in pad 20 wirelessly transfer electricity from electric grid 16 to vehicle receiver coil 6 (FIG. 2) which, within the very short period of time, literally seconds, it takes to drive over pad 20, supercapacitor module 2 is sufficiently charged to power the vehicle's electric motor 4 at least to the next changing pad, where the process is repeated. As depicted in FIG. 3, roadway 100 comprises charging pads 20, 21 and 22. Depending on the electrical capability and energy efficiency of the charging system, a typical pad may be between 40 and 100 meters in length interconnected by regular roadway sections 100, 102, and 104 each approximately 1000 meters in length. This continuous charging array creates a potentially limitless drive system.

Increasing supercapacitor size and thus electrical capacity may also allow an auxiliary vehicle battery to be charged by extra energy quickly stored in the supercapacitor, to power the vehicle on a non-electrified road.

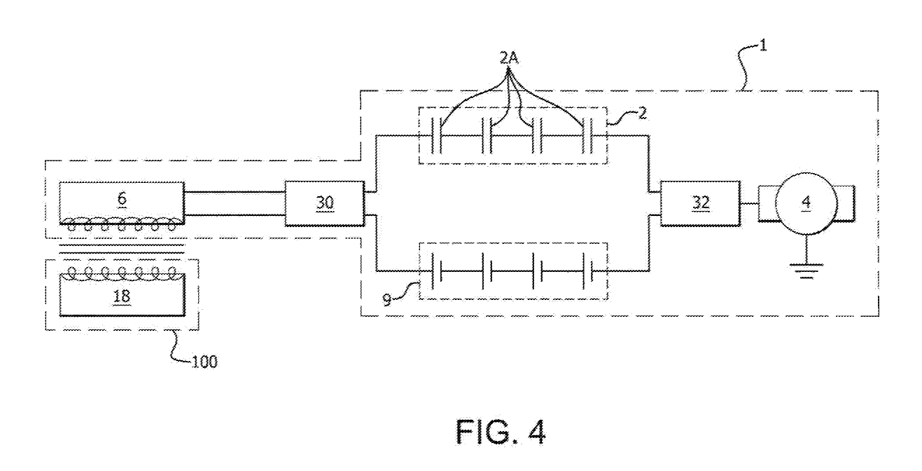

The schematic shown in FIG. 4 depicts the basic circuitry of the supercapacitor system. Transmitter coil 18, impeded in roadway 100, wirelessly transfers electrical energy to receiver coil 6 which, through controller 30 actuated by controller switch 32, charges supercapacitor module 2, comprising supercapacitor cells 2A placed in series. Supercapacitor module 2 powers electric motor 4. Battery bank 9 is provided to supply supplemental electrical energy, if needed.

The supercapacitor used in the vehicles of the present system are very quick to charge and do not require continuous charging. Periodic traveling over a charging zone maintains the energy to run the vehicles continuously. As a result, the roadway system infrastructure, i.e. construction and incorporation of charging pads, can be materially reduced. Basic laboratory testing indicates that 10% of the overall cost of the roadway infrastructure would be attributed to the charging pad and its components. Based on present day costs of construction, it is estimated that costs would be between $200,000 to $300,000 additional per mile, relatively inexpensive, given the systems significant long-term advantages.

### Test Results

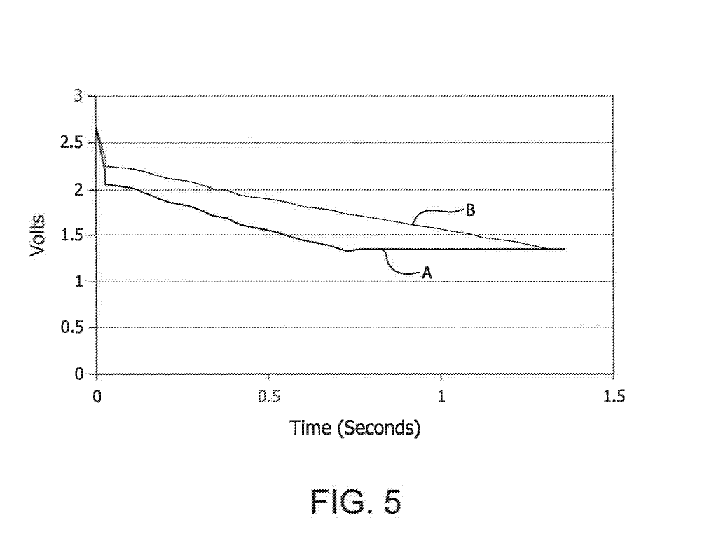

The high current/power capabilities of the supercapacitor of the present invention has been tested by utilizing a small single supercapacitor cell, 30 mm×50 mm×8 mm. The supercapacitor had a weight of 2.4 g, an ESR of 300 mΩ and a 7F capacitance. FIG. 5 is a graph depicting the comparison between two charging conditions. Line A represents a quick charge (1.5 seconds) condition and Line B represents a full charge (60 seconds). In both cases, the supercapacitor was charged to 2.7 volts and then discharged to 1.35 volts. The 1.5 second charge reached 1.35 volts in 0.8 seconds, while the 60 second charge reached the same voltage in 1.4 seconds. In other words, the 1.5 second charging held approximately one half the charge compared to the 60 second charge.

In charge/discharge experiments with the above described supercapacitor, it was found that a charge of 60 seconds and longer (for example for ten minutes) showed no significant difference in the discharge characteristics. Discharge behavior from 2.7 volts down to 1.35 volts was nearly identical whether the supercapacitor was charged for 60 seconds or ten minutes. Charging for any period of time exceeding 60 seconds did not improve the stored energy. A short charging time is important, because this will dictate the length of the charging zone and ultimately the total per kilometer cost of the system.

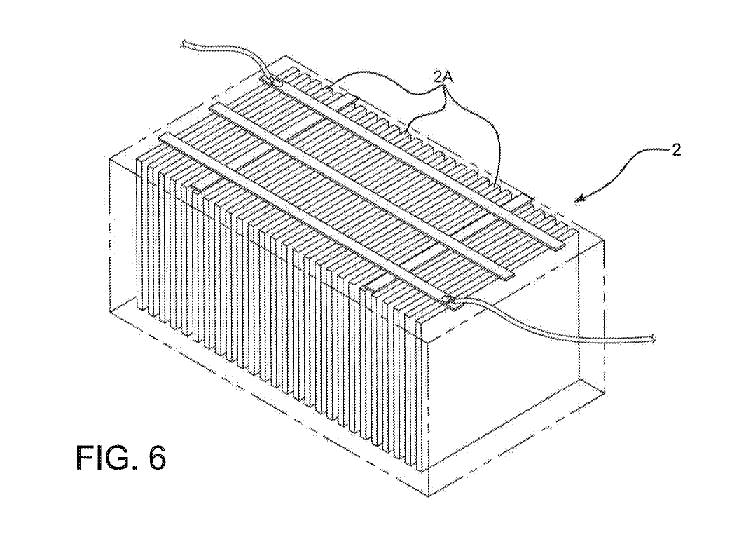

This data from a single supercapacitor cell can be extrapolated to the supercapacitor modular to be used in a four wheeled vehicle. Such a module 2, an example of which is shown in FIG. 6, would comprise approximately forty eight separate supercapacitor cells 2A interconnected to provide higher electrical capacities. The number of cells could be varied, depending on the particular voltage requirement of the vehicle. The modular would have a weight of 240 kg and hence an additional run of 2514 meters upon being wirelessly charged for 1.5 seconds, after running over a 46 m charging pad.

Using these parameters, consideration is given to a supercapacitor vehicle travelling an access controlled road at 70 mph or 31 m/s. A wireless charging pad 46 meters in length would provide a charging time of 1.5 seconds and thus increase vehicle range by 2500 meters. A second pad of the same length at the mile (1.6 km) marker, thus would continue to propel the car to the next marker a mile away. In this example, 46 meter pads every 1600 meters are sufficient to keep a supercapacitor vehicle moving at 70 mph indefinitely. Of course it is understood that in this example, the width of the pads, the charging currents, the distance between the charging pad and the supercapacitor vehicle are all optimized for the most efficient transfer of charge. Different supercapacitor vehicle characteristics, charging pad widths and types and number of transmitter coils, roadway distances, and other factors may be modified to achieve different results.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A vehicle comprising:
an electric motor operating a vehicle transmission;
a supercapacitor, said supercapacitor comprising the primary source of electricity to power the electric motor and operate the vehicle transmission; and
means for receiving electrical energy from a remotely positioned wireless electrical charger and for providing that electrical energy to the supercapacitor.

2. The vehicle as in claim 1 wherein the means for receiving and for providing electrical energy comprises an electrical energy receiver coil.

3. The vehicle as in claim 1 wherein the supercapacitor comprises a modular unit having a series of supercapacitor cells.

4. The vehicle as in claim 3 wherein the modular unit comprises approximately forty eight cells.

5. A roadway based electrical transportation system comprising:
a plurality of wireless electrical chargers, each wireless charger located in spaced relation with each other along a vehicle trafficked roadway;
a vehicle comprising:
an electric motor operating a vehicle transmission;
a super capacitor, said supercapacitor comprising the primary source of electricity to power the electric motor and operate the vehicle transmission; and
means for receiving electrical energy from the wireless chargers and for providing that electrical energy to the supercapacitor, whereby as the vehicle moves along the roadway, the supercapacitor is continuously being electrically charged by the wireless chargers to provide continuous electricity to power the electric motor and to operate the vehicle transmission.

6. The system as in claim 5 wherein the wireless chargers are embedded within the roadway,

7. The system as in claim 5 wherein the wireless chargers are embedded in charging pads in the roadway.

8. The system as in claim 5 wherein the wireless chargers are embedded in a plurality of charging pads positioned successively in the roadway.
